(19) United States
(12) Patent Application Publication
(10) Pub. No.: US 2023/0193812 A1
(43) Pub. Date: Jun. 22, 2023

(54) RADIAL TURBINE WITH VTG GUIDE GRID

(71) Applicant: BorgWarner Inc., Auburn Hills, MI (US)

(72) Inventors: Nico Kanoffsky, Bolanden (DE); Thomas Ramb, Worms (DE)

(21) Appl. No.: 17/679,377

(22) Filed: Feb. 24, 2022

(30) Foreign Application Priority Data
Dec. 21, 2021 (DE) 10 2021 134 071.3

(51) Int. Cl. F02B 33/34; F01D 9/04

(52) U.S. Cl. CPC F02B 33/34; F01D 9/041; F05D 2220/40

(57) ABSTRACT

A radial turbine for a charging device with a turbine casing, a turbine wheel, a VTG guide grid, and a plurality of spacing elements. The spacing elements are arranged on the vane bearing ring and define an axial distance of the vane bearing ring from the turbine casing or from a counter-element arranged in the turbine casing. At least one spacing element is arranged adjacent to a guide vane and is configured such that a minimum distance between the at least one spacing element and the associated adjacent guide vane is achieved in a specific operating position of the guide vane in which the minimum distance is formed by a difference between an axial distance and an inflow distance.

### TECHNICAL FIELD

The present invention concerns a radial turbine for a charging device. The invention furthermore concerns a charging device with such a radial turbine.

### BACKGROUND

More and more vehicles of recent generations are equipped with charging devices in order to achieve the demand objectives and fulfil legal requirements. In the development of charging devices, both the individual components and the system as a whole must be optimized with respect to reliability and efficiency.

Known charging devices usually comprise at least one compressor with a compressor wheel which is connected to a drive unit via a common shaft. The compressor compresses the fresh air drawn in for the internal combustion engine or fuel cell. This increases the quantity of air or oxygen available to the engine for combustion or to the fuel cell for reaction. This in turn leads to a performance increase of the internal combustion engine or fuel cell. Charging devices may be equipped with various drive units. In the prior art, in particular electric chargers are known in which the compressor is driven via an electric motor, and turbochargers in which the compressor is driven via a turbine, in particular a radial turbine. In contrast to an axial turbine, such as for example in aircraft engines, in which the inflow is substantially exclusively axial, in a radial turbine the exhaust gas flow is conducted onto the turbine wheel substantially radially from a spiral turbine inlet, and in the case of a mixed flow radial turbine, semi-radially, i.e. with at least a slight axial component. As well as electric chargers and turbochargers, the prior art also describes combinations of the two systems, known as E-turbo systems.

In order to increase the efficiency of turbines and adapt these to different operating points, frequently variable guide vanes are used in turbines; said variable guide vanes can be adjusted such that an angle of attack and a flow cross-section of the flow conducted onto the turbine wheel can be set variably. Such systems are known as variable turbine geometry or VTG, guide grids or VTG guide grids.

Known guide grids often comprise a vane bearing ring with a plurality of guide vanes mounted on this vane bearing ring in the form of a crown, wherein each guide vane is adjustable from a substantially tangential position relative to the crown into an approximately radial position. An actuating device is provided for generating control movements to be transmitted to the guide grid with variable turbine geometry via an adjustment ring, which is arranged coaxially with the vane bearing ring and to which the guide vanes are movably connected. The actuating device usually comprises an actuator which is coupled to the adjustment ring via an adjustment shaft arrangement. For mechanical coupling of the actuating device to the adjustment ring, frequently an inner lever engages with an actuating pin of the adjustment ring. The plurality of movable components of the VTG guide grid frequently necessitates complex and cost-intensive assembly and may lead to wear problems in operation. Since the VTG guide grid usually defines at least part of the flow channel from the turbine volute to the turbine wheel, it is furthermore important to ensure a precise positioning of the VTG guide grid. This may be achieved for example by axial preloading of the VTG guide grid in the turbine casing. It is important to ensure a variable adjustment of the guide vanes appropriate for the respective operating state, i.e. a movability. Here there are various methods which in turn may entail disadvantages with respect to the flow properties, efficiency, manufacturing complexity, component size, and not least production costs.

The object of the present invention is to provide a radial turbine with improved VTG guide grid in relation to the above disadvantages.

### SUMMARY OF THE INVENTION

The present invention concerns radial turbines for a charging device as claimed in claim 1. The invention furthermore concerns a charging device with such a radial turbine as claimed in claim 15.

The radial turbine for a charging device comprises a turbine casing, a turbine wheel, a VTG guide grid, and a plurality of spacing elements. The turbine casing defines a supply channel and an outlet channel. The turbine wheel is arranged in the turbine casing between the supply channel and the outlet channel. The VTG guide grid comprises a vane bearing ring and a plurality of guide vanes. The guide vanes are mounted rotatably in the guide vane ring along a respective vane axis. The guide vanes each have a leading edge and a trailing edge. The guide vanes each have a vane length between the leading edge and the trailing edge. The spacing elements are arranged on the vane bearing ring and distributed in the circumferential direction such that they define an axial distance of the vane bearing ring from the turbine casing or from a counter-element arranged in the turbine casing. At least one spacing element of the plurality of spacing elements is arranged adjacent to a guide vane of the plurality of guide vanes, and is configured such that a minimum distance between the at least one spacing element and the associated adjacent guide vane is achieved in a specific operating position of the guide vane, in which the minimum distance is formed by a difference between an axial distance and an inflow distance. The axial distance corresponds to the distance of the vane axis from the spacing element. The inflow distance corresponds to the distance of the vane axis from the leading edge. Because of the particular arrangement of the at least one spacing element relative to the associated adjacent vane, an optimum between efficiency, component size and costs can be achieved. It has been found that a small minimum distance with respect to the VTG guide grid is particularly advantageous. Two large or too small a distance may lead to faults on the guide vane because of wake turbulence, and hence to efficiency losses, in particular in operating positions in which the guide vanes are in the lee of the spacing elements. Overall, the provision and in particular the arrangement of the spacing elements allow the provision of a radial turbine with VTG guide grid which is improved in terms of thermodynamics and load-bearing capacity.

In embodiments of the radial turbine, distances from the at least one spacing element to all guide vanes other than the associated adjacent guide vane in each operating position of the guide vanes may be greater than the minimum distance.

In embodiments which may be combined with the preceding embodiment, the associated adjacent guide vane in the specific operating position for achieving the minimum distance may be oriented with the leading edge in the direction of the spacing element.

In embodiments which may be combined with any of the preceding embodiments, the axial distance may be greater than the inflow distance. This ensures that the guide vanes can swivel past the associated spacing element without collision.

In embodiments which may be combined with any of the preceding embodiments, the minimum distance may exist between the leading edge and the spacing element.

In embodiments which may be combined with any of the preceding embodiments, the VTG guide grid may be configured such that a ratio V ₁ of the minimum distance to the vane length lies in a range from 0.01 to 0.1. Preferably, the ratio V ₁ of the minimum distance to the vane length may lie in a range from 0.02 to 0.05. Particularly preferably, the ratio V ₁ of the minimum distance to the vane length may lie in a range from 0.025 to 0.040. In particular, the particularly preferred range has proved particularly advantageous in the overall operation of the VTG guide grid.

In embodiments which may be combined with any of the preceding embodiments, one, several or all spacing elements may be designed to be substantially cylindrical. Alternatively, one, several or all spacing elements may be configured as blades. Cylindrical may include shapes which have a changing diameter in the axial direction. Alternatively or additionally, cylindrical spacing elements may comprise oval cross-sectional shapes, and/or ones deviating from a perfect circle. Preferably, the spacing elements may have a round cross-sectional form. This may provide a more economic production of the VTG guide grid. Also, for example, in comparison with a complex pre-guide grid and in particular on use of oval or circular cross-sections, a simple structure and simple production may be achieved.

In embodiments which may be combined with any of the preceding embodiments, the spacing elements may each comprise an engagement portion and a spacing portion. In some embodiments, the spacing elements may be configured for arrangement, in particular press-fit, via the engagement portion in one of the vane bearing ring or turbine casing, in particular in a counter-element arranged in the turbine casing. By inserting the spacing elements in just one of the other elements of the radial turbine, simple assembly becomes possible. Also, simple support or contact of the spacing element on the opposite element may be possible. In some embodiments, the spacing portion may be arranged in contact with a contact face of the other of the vane bearing ring or the turbine casing, in particular a counter-element arranged in the turbine casing. This achieves more economic and simpler production due to simple contact on the contact face opposite the engagement portion. In some embodiments, the contact face may be designed to be wear-resistant. For example, the contact face or the associated element may be coated with a wear-resistant coating or have a hardened surface or contact face. This may achieve a longer service life of the radial turbine.

In embodiments which may be combined with any of the preceding embodiments, the spacing elements may each comprise a support portion with a support diameter which is axially arranged between the engagement portion and the spacing portion. Alternatively or additionally, the support diameter may be greater than an engagement diameter of the engagement portion. Alternatively or additionally, the support diameter may be greater than a spacing diameter of the spacing portion. Because of the additional support portion, a better force transfer between the spacing element and the vane bearing ring or turbine casing or counter-element may be achieved, depending on which of these elements receives the engagement portion. In some embodiments, the spacing diameter may be greater than the engagement diameter. Because of the smaller engagement portion, a more economic device may be provided.

In embodiments which may be combined with any of the preceding embodiments, a spacing diameter of the spacing portion may be greater than an engagement diameter of the engagement portion. Because of the smaller engagement portion, a more economic device may be provided.

In embodiments which may be combined with any of the preceding embodiments, the spacing elements may be configured such that a ratio V₂ of the engagement diameter to the spacing diameter lies in a range from 0.5 to 1.0, preferably in a range from 0.6 to 0.95, and particularly preferably in a range from 0.7 to 0.9. This may allow a particularly compact construction at low cost.

In embodiments which may be combined with any of the preceding embodiments, the plurality of guide vanes may be greater than the plurality of spacing elements. Alternatively or additionally, in preferred embodiments, a spacing element may be arranged at least in every second intermediate channel between adjacent guide vanes. This may ensure a particularly good stability of the VTG guide grid. In particular, the force may be evenly distributed over the adjustment ring.

In embodiments which may be combined with any of the preceding embodiments, a ratio V₃ of the plurality of guide vanes to the plurality of spacing elements lies in a range from 1.1 to 3.0, preferably in a range from 1.5 to 2.5, and particularly preferably in a range from 1.75 to 2.25. In particular, the particularly preferred range constitutes an optimum trade-off between increasing the load-bearing capacity and reducing the fluidic influencing.

In embodiments which may be combined with any of the preceding embodiments, the plurality of spacing elements may comprise a number between one and twenty, in particular between two and fifteen, preferably between three and ten. In particular, the plurality of spacing elements may comprise at least three spacing elements, preferably precisely three or four spacing elements. This allows a reduction in the tilt risk and an improved force distribution.

In embodiments which may be combined with any of the preceding embodiments, the radial turbine may furthermore comprise a spring. The spring may in particular be configured as a cup spring. The spring may be designed and arranged to preload the VTG guide grid in the axial direction in the turbine casing. The spring may in particular lie in direct or indirect contact with the vane bearing ring. The spacing elements may be designed to transfer the preload force from the vane bearing ring to the turbine casing or to a counter-element arranged in the turbine casing. The preload may also be achieved by alternative methods other than with a spring.

In embodiments which may be combined with any of the preceding embodiments, the guide vanes may each comprise a vane shaft and lever. The vane levers may be operatively coupled with an adjustment ring of the VTG guide grid. The guide vanes may be mounted rotatably in the vane bearing ring via the guide shafts and distributed in the circumferential direction. The vane shafts may extend in the axial direction. In other words, the vane shafts may extend parallel to the rotational axis R of the turbine wheel.

In embodiments which may be combined with any of the preceding embodiments, the guide vanes may be adjustable between a first position, in particular a first end position, and a second position, in particular a second end position. The first position may correspond to a maximally opened position of the VTG guide grid. The second position may correspond to a minimally opened position of the VTG guide grid. In this way, a fluid flow from the supply channel can be conducted variably onto the turbine wheel through the flow channel, i.e. where the guide vanes are arranged. In some embodiments, the respective center axes of the spacing elements may be arranged radially inside an envelope circle diameter D_{Smax}. The envelope circle diameter D_{Smax} may be formed by positions of the leading edges in the maximally opened position of the VTG guide grid. In some embodiments, the center axes of the spacing elements may be arranged on an envelope circle with a center axis diameter D_{P}. A ratio V ₄ of the center axis diameter D_{P} to the envelope circle diameter D_{Smax} may lie in a range from 0.8 to 1.0, preferably in a range from 0.9 to 1.0, and particularly preferably in a range from 0.95 to 1.0. These particularly preferred embodiments leads to a more compact design with simultaneously as little fluidic influencing as possible. In particular in combination with a ratio V ₁ of minimum distance to vane length in the ranges described above, ratios can be achieved which are optimized fluidically and with respect to installation space, and hence also with respect to cost and production.

In embodiments which may be combined with any of the preceding embodiments, the counter-element may be configured as an annular element. In particular, the counter-element may be configured as a cover disc.

In embodiments which may be combined with any of the preceding embodiments, the VTG guide grid may be arranged radially outside the turbine wheel.

In embodiments which may be combined with any of the preceding embodiments, each spacing element of the plurality of spacing elements may be arranged adjacent to a respective guide vane of the plurality of guide vanes and configured such that a minimum distance is achieved between the respective spacing element and the respective associated adjacent guide vane in a specific operating position of the guide vane, in which the minimum distance is formed by a difference between the axial distance and the inflow distance.

In embodiments which may be combined with any of the preceding embodiments, each spacing element of the plurality of spacing elements may be arranged relative to a respective guide vane of the plurality of guide vanes and configured according to one or more of the features of any of the preceding embodiments.

The invention furthermore concerns a charging device for an internal combustion engine or a fuel cell. The charging device comprises a bearing housing, a shaft and a compressor with a compressor wheel. The shaft is mounted rotatably in the bearing housing. The charging device furthermore comprises a radial turbine according to any of the preceding embodiments. The turbine wheel and the compressor wheel are arranged rotationally fixedly at opposite ends on the shaft.

In some embodiments, the charging device may furthermore comprise electric motor. The electric motor may be configured to drive the shaft in rotation.

In embodiments of the charging device which may be combined with the preceding embodiment, and if the radial turbine comprises a spring which is designed and arranged to preload the VTG guide grid in the axial direction in the turbine casing, the spring may be clamped between the bearing housing and the vane bearing ring.

### BRIEF DESCRIPTION OF THE FIGURES

FIG. 1a shows a sectional, perspective illustration of the general structure of a charging device according to the invention;

FIG. 1b shows a sectional illustration of a part of the charging device according to the invention, with the spacing elements resting on a disc-like counter-element;

FIG. 1c shows the sectional illustration as in FIG. 1b, wherein the spacing elements rest directly on the turbine casing;

FIG. 2a shows the VTG guide grid in top view;

FIG. 2b shows the detail extract “A” of the VTG guide grid from FIG. 2a;

FIG. 3 shows an exemplary spacing element in a side view;

FIGS. 4a-4b show a perspective illustration and an exploded view of the VTG guide grid with disc-like counter-element.

### DETAILED DESCRIPTION

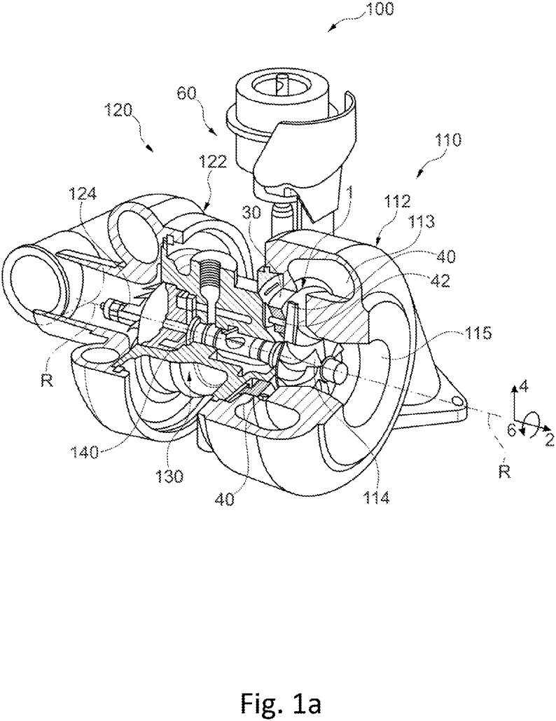

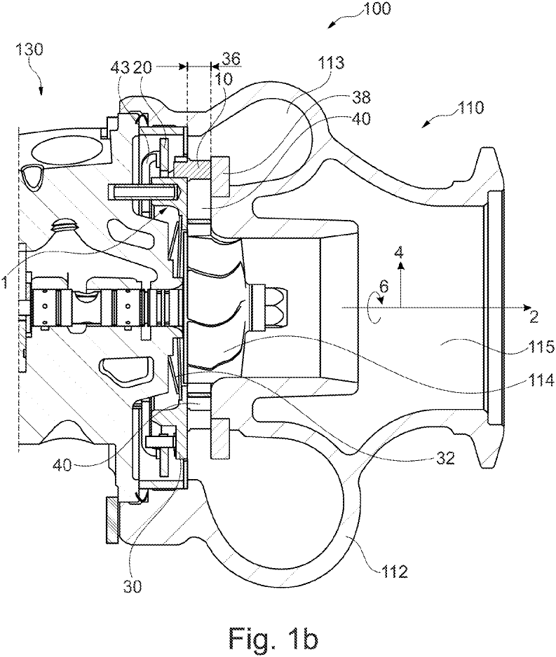

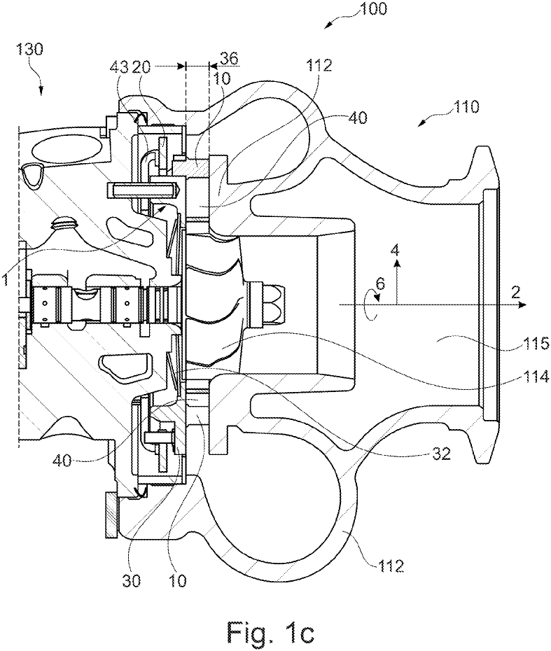

In the context of this application, the terms “axial” and “axial direction” relate to a rotational axis of the radial turbine 110 or turbine wheel 114 and/or VTG guide grid 1 or vane bearing ring 30. With reference to the Figures (see e.g. FIG. 1a), the axial direction of the radial turbine 110 or VTG guide grid 1 is designated with reference sign 2. A radial direction 4 relates to the axis/axial direction 2 of the radial turbine 110 or VTG guide grid 1. Similarly, a circumference or circumferential direction 6 relates to the axis/axial direction 2 of the radial turbine 110 or VTG guide grid 1.

FIG. 1a shows a charging device 100 according to the invention which comprises a radial turbine 110, a compressor 120 and a bearing housing 130.

The radial turbine 110 comprises a turbine casing 112, a turbine wheel 114 and a VTG guide grid 1. The VTG guide grid 1 is illustrated merely schematically in FIG. 1 and is explained in detail below in relation to the other figures. The turbine casing 112 defines a supply channel 113 and an outlet channel 115. The turbine wheel 114 is arranged in the turbine casing 112 between the supply channel 113 and the outlet channel 115. The supply channel 113 may also be described as the turbine volute. The VTG guide grid 1 is arranged radially outside the turbine wheel 114. More precisely, the VTG guide grid 1 is arranged between the supply channel 113 and the turbine wheel 114.

The compressor 120 comprises a compressor housing 122 and a compressor wheel 124 mounted rotatably therein. The charging device 100 furthermore comprises a shaft 140 which is rotatably mounted in the bearing housing 130. The turbine wheel 114 and the compressor wheel 124 are arranged rotationally fixedly at opposite ends on the shaft 140. The housings 112, 130 and 122 are arranged along a rotational axis R of the shaft 140.

In principle, the charging device 100 may be used for an internal combustion engine or a fuel cell, and/or be designed or dimensioned accordingly.

In the embodiment of FIG. 1a, the charging device 100 is configured as a turbocharger. In some embodiments, the charging device 100 may be configured as a E-turbo (not shown in the figures). For example, the charging device 100 may furthermore comprise an electric motor. In some embodiments, the electric motor may be arranged in the bearing housing 130. The electric motor may be configured to drive the shaft 140 in rotation. In some embodiments, an electromagnetically active element may be arranged on the shaft 140. The electric motor or its stator may be designed to drive the electromagnetically active element and hence the shaft 140 itself in rotation.

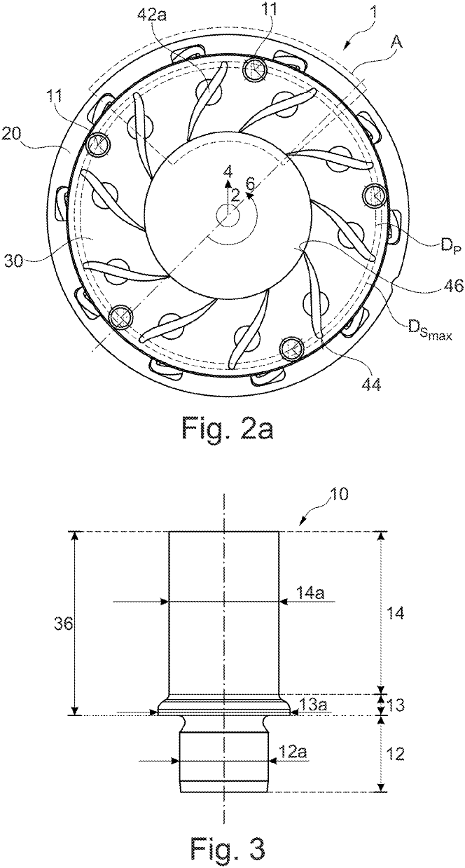

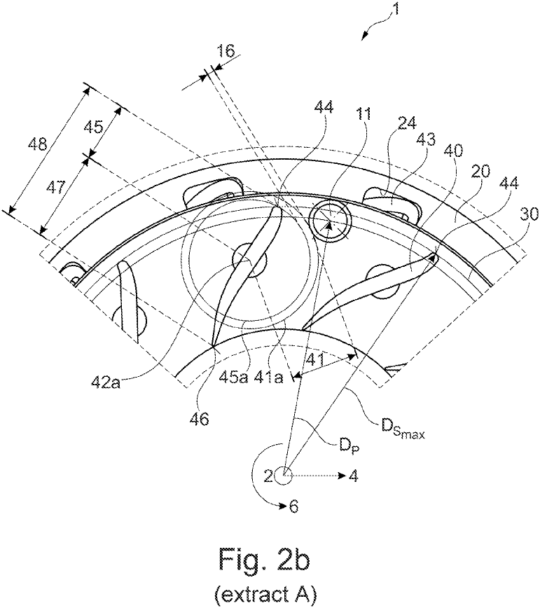

The turbine casing 112 is shown partially in cross-section in FIG. 1a in order to illustrate the arrangement of a vane bearing ring 30 as part of the VTG guide grid 1, which comprises a plurality of guide vanes 40 distributed in the circumferential direction 6 and with pivot axes 42a (also known as vane axes 42a) or vane shafts 42. The guide vanes 40 are adjustable between a first position, in particular a first end position, and a second position, in particular a second end position. Several intermediate positions may be set between the first and second positions. The first position corresponds to a maximally opened position of the VTG guide grid 1 (see FIG. 2a). The second position corresponds to a minimally opened position of VTG guide grid 1 (not shown, but more tangentially clockwise than in FIG. 2a). In this way, a fluid flow from the supply channel 113 can be conducted variably onto the turbine wheel 114 through a flow channel, i.e. where the guide vanes 40 are arranged. Nozzle cross-sections (also called intermediate channels) are formed between adjacent guide vanes 40 and may be larger or smaller depending on the momentary position of the guide vanes 40, and accordingly load the turbine wheel 114 mounted on the rotational axis R with a larger or smaller quantity of exhaust gases from an internal combustion engine or fuel cell, in order to drive the compressor wheel 124 sitting on the same shaft 140 via the turbine wheel 114. The guide vanes 40 each have a leading edge 44 and a trailing edge 46. The guide vanes 40 each have a vane length 48 between the leading edge 44 and the trailing edge 46. The vane length 48 may be regarded as the distance between the leading edge 44 and the trailing edge 46. The leading edge 44 may be regarded as an inflow region of the guide vane 40 with maximum distance from a vane axis 42a. The trailing edge 46 may be regarded as an outflow region of the guide vane 40 with maximum distance from a vane axis 42a. In other words, the trailing edge 46 lies downstream of the leading edge 44 viewed in a flow direction along the guide vane 40. A position of the guide vanes 40 may also be designated a position or operating attitude or operating position. Thus each possible position of a guide vane 40 during operation of the radial turbine 110 lies between the first position of maximal opening/flow cross-section (i.e. maximally opened) and the second position of minimum opening/flow cross-section (i.e. minimally opened or maximally closed). Each “possible position” means any position which may be provided in operation. It is known to the person skilled in the art that the operating positions change variably and automatically during operation of the radial turbine.

In order to control the movement or position of the guide vanes 40, an actuating device 60 may be provided which may itself be configured in any manner, e.g. electronically or pneumatically, to name just two examples. In the example of FIG. 1a, the actuating device is configured pneumatically with a control housing (e.g. a pressure box) and a ram element which transmits the movement of the control housing via one or more intermediate elements, in particular via an adjustment shaft arrangement, to the VTG guide grid 1 or guide vanes 40.

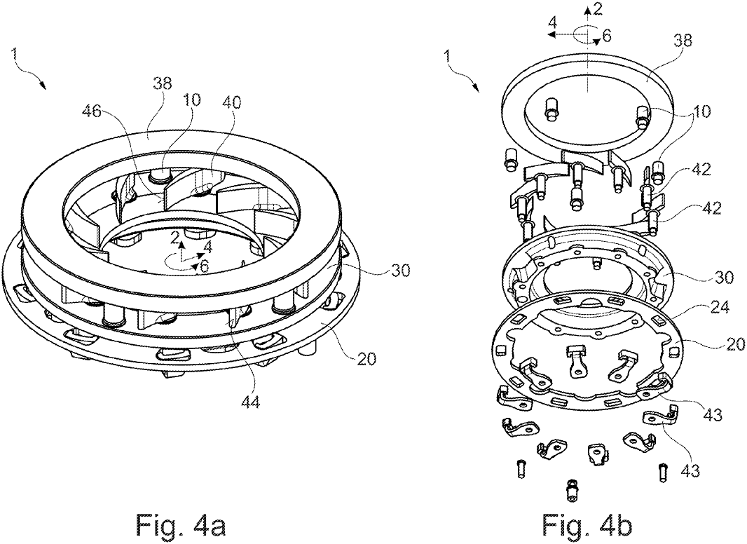

In this respect, FIGS. 1b and 1c show a detail extract of the VTG guide grid 1 installed in the radial turbine 110, in a side sectional view. The VTG guide grid 1 comprises, as well as the vane bearing ring 30 and guide vanes 40, an adjustment ring 20 via which the guide vanes 40 are adjusted or rotated. The plurality of guide vanes 40 is mounted rotatably in the vane bearing ring 30. More precisely, the guide vanes 40 each have a vane shaft 42 (see FIG. 4b) via which they are mounted rotatably in the vane bearing ring 30. In other words, the guide vanes 40 may be mounted rotatably in the vane bearing ring 30 via the guide shafts 42 and distributed in the circumferential direction 6. The vane shafts 42 here extend in the axial direction 2, i.e. parallel to the rotational axis R. In other words, the guide vanes 40 are mounted rotatably in the vane bearing ring 30 along a respective vane axis 42a.

With reference to FIGS. 4a and 4b, it is clearly evident that the guide vanes 40 each have a guide lever 43 via which they are coupled to the adjustment ring 20. The adjustment ring 20 may for this have engagement openings 24 in which the vane levers 43 engage operatively. For this, the engagement openings 24 are arranged in the adjustment ring 20 and distributed in the circumferential direction 6. For coupling with the actuating device 60, the adjustment ring 20 has an actuating pin (without reference sign, see far bottom of FIG. 4b). The actuating pin may be produced integrally with the adjustment ring 20 or fixed to the adjustment ring 20, for example form of a weld bolt. Via an adjustment shaft arrangement with levers (not shown in Figures), the VTG guide grid 1 or adjustment ring 20 can be coupled to the actuating device 60. The coupling of the actuating device 60 to the VTG guide grid 1 via the adjustment shaft arrangement may take place via other transmission mechanisms well known to the person skilled in the art. The mechanism of adjustment via guide levers 43 and adjustment ring 20, an adjustment shaft arrangement and actuating device 60, may also be implemented differently. Accordingly, the VTG guide grid 1 may also be designed without adjustment ring 20 and/or without vane levers 43. The variable adjustability of the guide vanes 40, with several operating positions between the first and second position during operation, is important.

As evident in particular from FIGS. 1b, 1c and 2, the radial turbine 110 furthermore comprises a plurality of spacing elements 10. The spacing elements 10 are arranged on the vane bearing ring 30 and distributed in the circumferential direction 6 such that they define an axial distance 36 of the vane bearing ring 30 from the turbine casing 112 or from a counter-element 38 arranged in the turbine casing 112. The axial distance 36 ensured by the spacing elements 10 is advantageous to prevent or at least reduce any blocking, braking or stopping of the guide vanes 40 during adjustment. In other words, the axial distance 36 ensured by the spacing elements 10 is advantageous to allow rotation of the guide vanes 40. The reason is that in installed state, the VTG guide grid 1 is preloaded in the axial direction 2 in the turbine casing 112. Without additional spacing means, the guide vanes 40 would perform the force transfer. This means that without additional spacing means, the guide vanes 40 would be pressed to the right in the illustration of FIGS. 1b and 1c, against the turbine casing 112 or counter-element 38. By providing the spacing elements 10, the force transfer takes place via the spacing elements 10. The spacing elements 10 are configured such that they have a greater axial length than the guide vanes 40 in the region between the vane bearing ring 30 and the turbine casing 112 or counter-element 38. In other words, the spacing elements 10 space the vane bearing ring 30 in the axial direction 2. This means that the spacing elements 10 are arranged on the same axial side of the vane bearing ring 30 as the guide vanes 40. The spacing elements 10 are thus arranged in the flow region from the supply channel 113 to the turbine wheel 114. In other words, a flow region (also designated a flow channel) is formed between the vane bearing ring 30 and the turbine casing 112 or counter-element 38. The flow channel is a substantially annular flow region through which fluids are conducted from the supply channel 113 via the guide vanes 40 onto the turbine wheel 114. The expression “on the vane bearing ring 30” means that spacing elements 10 are arranged substantially radially inside an outer periphery of the vane bearing ring 30. This means that the force transfer takes place via the vane bearing ring 30. Preferably, and as shown in FIGS. 2a and 2b, spacing elements 10 are arranged completely radially inside the outer periphery of the vane bearing ring 30. It is clear to the person skilled in the art that the spacing elements 10 cannot be arranged radially inside an inner periphery of the vane bearing ring 30 else collisions with the turbine wheel 114 would occur.

In this respect, FIGS. 1b and 1c show two different designs of the radial turbine 110 which differ in that, in FIG. 1b, an additional counter-element 38 is arranged in the turbine casing 112. Here, a respective spacing element 10 ensures an axial distance 36 between the vane bearing ring 30 and the counter-element 38. In the present example, the counter-element 38 is configured as an annular element, e.g. a cover disc. Alternatively, the counter-element 38 may also be configured differently in order to fulfil the purpose of the counter-bearing. As clearly evident from FIG. 1b, the flow channel is formed at least partially between the cover disc 38 and the vane bearing ring 30. In the radially inner region, a flow channel is formed between the turbine casing 112 and the vane bearing ring 30. In alternative embodiments, the counter-element 38 could also be configured such that the flow channel is formed exclusively or largely between the counter-element 38 and the vane bearing ring 30. For this, the counter-element 38 could for example extend further radially inward and/or in the axial direction 2 towards the outlet channel 115. In contrast to the design of FIG. 1b, the radial turbine 110 of FIG. 1c has no cover disc 38. Here, a respective spacing element 10 ensures an axial distance 36 between the vane bearing ring 30 and the turbine casing 112. The turbine casing 112 is configured such that it supports the spacing elements axially. In the example of FIG. 1c, a region of the turbine casing 112 extends further radially outward between the supply channel 113 and the turbine wheel 114. With such designs, the component complexity and costs may be reduced since no additional counter-element is required.

As evident in particular from FIGS. 2a and 2b, at least one spacing element 10 of the plurality of spacing elements 10 is arranged adjacent to a guide vane 40 of the plurality of guide vanes 40, and configured such that a minimum distance 16 between the at least one spacing element 10 and the associated adjacent guide vane 40 is achieved in a specific operating position of the guide vane 40, in which the minimum distance 16 is formed by a difference between an axial distance 41 and an inflow distance 45. The axial distance 41 corresponds to a distance of the vane axis 42a from the spacing element 10. The inflow distance 45 corresponds to a distance of the vane axis 42a from the leading edge 44. The axial distance 41 is greater than the inflow distance 45. In this way, the guide vanes 40 can swivel past the associated spacing element 10 without collision. Thanks to the particular arrangement of the at least one spacing element 10 relative to the associated adjacent guide vane 40, an optimum can be achieved between efficiency, component size and costs. It has been found that a small minimum distance 16 relative to the VTG guide grid 1 is particularly advantageous. Too large or too small a distance may lead to faults on the guide vane 40 because of wake turbulence and hence to efficiency losses, in particular in operating positions in which the guide vanes 40 are in the lee of the spacing elements 10. As a whole, by the provision and in particular the arrangement of the spacing elements 10, a radial turbine 110 with VTG guide vane 1 can be provided which is improved in terms of thermodynamics and load-bearing capacity. The expression “is achieved in a specific operating position of the guide vane 40” means that the minimum distance 16 is only achieved in a single operating position of the guide vane 40. In other words, in all other operating positions, the distance between the guide vane 40 and the associated spacing element 10 is greater than the minimum distance 16.

Although in this application, sometimes the phrase “at least one spacing element 10” is used, it should be clear to the person skilled in the art that the features explained in the entire description may be applied in principle partially or completely to one spacing element 10, several spacing elements 10 or all spacing elements 10.

The “associated adjacent guide vane 40” (or “associated guide vane 40”) for a spacing element 10 may mean the guide vane 40 which, on reaching the operating position in which the minimum distance 16 exists (the “specific operating position”), points with its leading edge 44 towards the spacing element 10 with which the guide vane 40 is described as being associated. This means that a direction from the vane axis 42a to the spacing element 10 substantially corresponds to a direction from the vane axis 42a to the leading edge 44. The minimum distance 16 thus exists between the leading edge 44 and the spacing element 10. In other words, the minimum distance 16 exists when the leading edge 44 lies substantially on the straight line which constitutes a direct path from the vane axis 42a to the associated spacing element 10. In the example of FIG. 2a, the “associated adjacent guide vane 40” for a respective spacing element 10 is in each case the guide vane which is adjacent counterclockwise. Similarly, the spacing element 10 adjacent to a guide vane 40 clockwise is the spacing element 10 which is associated with this guide vane 40. Furthermore, the guide vane 40 may swivel past its associated spacing element 10 on both sides. In other words, the guide vane 40 having an associated spacing element 10 can be swiveled from the “specific operating position” to both sides (in the example of FIGS. 2a and 2b, counterclockwise in the direction of the first position, and clockwise in the direction of the second position). On swiveling from the “specific operating position”, the distance between the spacing element 10 and the associated adjacent guide vane 40 at least does not become smaller, and preferably becomes larger. As evident in particular from FIG. 2b, the associated adjacent guide vane 40 in the specific operating position for achieving the minimum distance 16 is oriented with the leading edge 44 in the direction of the (associated) spacing element 10. Distances from the at least one spacing element 10 to all guide vanes 40 other than the associated adjacent guide vane 40 are greater than the minimum distance 16 in each operating position of the guide vanes 40. In other words, no other guide vane 40 stands closer to the spacing element 10 than the “associated adjacent guide vane 40”.

The term “axial distance 41” may be understood as the shortest distance of the vane axis 42a from the (associated) spacing element 10. The minimum distance 16 means the distance which, in operation of the VTG guide grid 1, can occur as a minimum between a spacing element 10 and a guide vane 40. As evident from FIG. 2b itself, the distances and spacings shown there are measured in the radial plane.

In the examples shown in FIGS. 2a and 2b, the VTG guide grid is configured such that a ratio V₁ of the minimum distance 16 to the vane length 48 lies in a range from 0.025 to 0.040. In alternative embodiments, the VTG guide grid 1 may also be configured such that a ratio V ₁ of the minimum distance 16 to the vane length 48 lies in a range from 0.01 to 0.1, or in a range from 0.02 to 0.05. Such a combination of dimensioning and positioning of the guide vanes 40 and spacing elements 10 has proved particularly advantageous in the overall operation of the VTG guide grid 1.

As clearly evident in FIG. 4b and in particular in FIG. 3, the spacing elements 10 are configured so as to be cylindrical and have a circular cross-section. This may achieve a more economic production of the VTG guide grid 1. Also, for example in comparison with a complex pre-guide grid, a simple structure and simple production can be achieved. As clearly evident in FIG. 3, the spacing elements 10 each have an engagement portion 12 and a spacing portion 14. The engagement portion 12 is the part of the spacing element 10 which engages in a holding element. The axial length of the spacing element 10 less the engagement portion 12 accordingly defines the axial distance 36. The spacing elements 10 are attached to the vane bearing ring 30 via the respective engagement portions 12. This can be achieved in a simple and low-cost fashion by press fit. For this, corresponding recesses are made in the vane bearing ring 30, or passage holes as shown in FIG. 4b. Alternative fixing possibilities well known to the person skilled in the art could also be used, wherein spacing elements 10 pressed into the vane bearing ring 30 particularly advantageously lead to a simple and low-cost production. In alternative embodiments, the spacing elements may, additionally or alternatively to fixing in the vane bearing ring 30, also be attached to the turbine casing 112 (design of FIG. 1c) or to the counter-element 38 (design of FIG. 1b). For this, the spacing elements need simply be rotated through 180° and pressed into or otherwise attached in corresponding recesses in the turbine casing 112 or counter-element 38. A second engagement portion axially opposite the engagement portion 12 would also be conceivable, wherein the second engagement portion is attached in the turbine casing 112 or counter-element 38.

By inserting the spacing elements 10 in only one element (vane bearing ring 30 or turbine casing 112 or counter-element 38), simple assembly can be achieved. Also, a simple support or contact of the spacing elements on the opposite element (turbine casing 112 or counter-element 38 or vane bearing ring 30) is possible.

In the examples illustrated (see for example FIGS. 1b and 1c), the spacing portion 14 is arranged in contact with a contact face of the turbine casing 112 (FIG. 1c) or in particular on a contact face of the counter-element 38 (FIG. 1b). Fixing on this side is not necessary since the spacing elements 10 are already attached to the vane bearing ring 30, or the engagement portions 12 are pressed therein, on the axially opposite side. In this way, a cheaper and simpler production can be achieved by simply resting on the contact face opposite the engagement portion 12. As shown in the embodiment of FIG. 1c, in particular a counter-element 38 may be omitted. The spacing elements 10 may rest in direct contact on the turbine casing 112. The contact face may be designed to be wear-resistant. For example, the contact face or the turbine casing 112 or the counter-element 38 may be coated with a wear-resistant coating. Alternatively, the turbine casing 112 or the counter-element 38 may have a hardened contact face. This may achieve a longer service life of the radial turbine 110. The term “wear-resistant” means having a high resistance against mechanical wear due e.g. to friction or pressure, in particular such as having a high hardness.

The spacing elements may be made from a metallic material, e.g. steel, in particular high-temperature steel. Other materials may be used which are resistant to high temperatures and able to transmit axial preload forces.

As further evident from FIG. 3, the spacing elements 10 may each comprise a support portion 13 which is arranged axially between the engagement portion 12 and the spacing portion 14. The support portion 13 has a support diameter 13a. The engagement portion 12 has an engagement diameter 12a. The spacing portion 14 has a spacing diameter 14a. At least the support diameter 13a is greater than the engagement diameter 12a. Furthermore, the support diameter 13a is greater than a spacing diameter 14a. Because of the additional support portion 13, a better force transfer can be achieved between the spacing element 10 and the vane bearing ring 30. This is further improved by the larger support diameter 13a in comparison with the spacing diameter 14a.

The spacing diameter 14a is greater than the engagement diameter 12a (see FIG. 3). In particular, the spacing elements 10 may be configured such that a ratio V₂ of the engagement diameter 12a to the spacing diameter 14a lies in a range from 0.5 to 1.0, preferably in a range from 0.6 to 0.95, and particularly preferably in a range from 0.7 to 0.9. In this way, a particularly compact structure can be provided at low cost. In principle, because of the smaller engagement portion 12, a cheaper device can be provided since less material is required for the spacing element 10, and a smaller receiver, in particular an opening or passage hole with smaller diameter, in the vane bearing ring 30. The above-mentioned respective diameters relate to the maximum diameter of the respective portions of the spacing element 10.

As an alternative to the round cross-sectional form described here, one, several or all spacing elements 10 may also be configured as blades. Alternatively or additionally, spacing elements 10 may comprise oval cross-sectional forms and/or ones deviating from a perfect circle. Preferably, the spacing elements 10 comprising a round cross-sectional form. In principle, the spacing elements 10 may be cylindrical. Cylindrical may include shapes which have a changing diameter in the axial direction 2.

In the example of FIG. 2a, the VTG guide grid 1 comprises ten guide vanes 40 and five spacing elements 10. In other words, the ratio V₃ of the plurality of guide vanes 40 to the plurality of spacing elements 10 is equal to 2. Such embodiments have proved particularly advantageous and constitute an optimum trade-off between increasing the load-bearing capacity and reducing the fluidic influencing. In principle, the number of guide vanes 40 may also be greater or smaller than ten. In particular, between two and forty guide vanes 40 may be used. The plurality of spacing elements 10 may comprise a number between one and twenty, in particular between two and fifteen, particularly preferably between three and ten. In particular, the plurality of spacing elements 10 may comprise at least three spacing elements 10, preferably precisely three or four spacing elements. Preferably, the plurality of spacing elements 10 may be between three and seven, for example precisely three, four, five, six or seven. In this way, the tilt risk may be reduced and an improved force distribution achieved. As well as the spacing elements specially described herein, in specific embodiments, further spacing means may be provided which are designed and/or arranged differently. Advantageously, the plurality of guide vanes 40 should be greater than the plurality of spacing elements 10. In other words, the VTG guide grid should comprise a greater number of guide vanes 40 than spacing elements 10. In principle, the ratio V₃ of the plurality of guide vanes 40 to the plurality of spacing elements 10 should lie in a range from 1.1 to 3.0, preferably in a range from 1.5 to 2.5, and particularly preferably in a range from 1.75 to 2.25. In particular, the particularly preferred range constitutes an optimum trade-off between increasing the load-bearing capacity and reducing the fluidic influencing. In preferred embodiments (as also in FIG. 2a), a spacing element 10 is arranged in every second intermediate channel (i.e. where nozzle cross-sections are formed) between adjacent guide vanes 40. In this way, a particularly good stability of the VTG guide grid 1 can be provided. In particular, the force can be distributed evenly over the adjustment ring 30.

As shown in particular in FIG. 2a, respective center axes 11 of the spacing elements 10 are arranged radially inside an envelope circle diameter D_{Smax}. The term “radially inside” here relates to the radial direction 4 with respect to the turbine wheel 114 or center point of the vane bearing ring 30. The envelope circle diameter is formed by positions of the leading edges 44 in the maximally opened position of the VTG guide grid 1, i.e. in the first position described above. A center axis 11 may be regarded as the axis at a center point between two lengths of the spacing element 10, wherein the two lengths are orthogonal to one another and lie in the radial plane. One of the two lengths corresponds to the maximum extent of the spacing element 10 (e.g. for oval or blade-like spacing elements 10). In the case of a circular spacing element, the center axis 11 lies on the circle center point. In some embodiments, the center axes 11 of the spacing elements 10 may be arranged on an envelope circle with a center axis diameter D_{P}. The diameters D_{Smax} and D_{P} cited in this paragraph relate to the center point of the vane bearing ring 30 (see FIG. 2b).

The VTG guide grid 1 is here configured such that a ratio V₄ of the center axis diameter D_{P} to the envelope circle diameter D_{Smax} lies in a range from 0.8 to 1.0, preferably in a range from 0.9 to 1.0, and particularly preferably in a range from 0.95 to 1.0. These advantageous embodiments lead to a more compact structure with simultaneously as little fluidic influencing as possible. In further preferred embodiments, the ratio V₄ may lie in a range from 0.8 to >1.0, in a range from 0.9 to >1.0, or in a range from 0.95 to >1.0. In other words, the center axis diameter D_{P} is smaller than the envelope circle diameter D_{Smax}. The envelope circle with the envelope circle diameter D_{Smax} is concentric with the envelope circle with center axis diameter D_{P}. In particular in combination with the above-defined ratio V₁, these embodiments allow ratios which are optimized fluidically and with respect to installation space, and hence also cost and production.

As evident from FIGS. 1b and 1c, the radial turbine 110 furthermore comprises a spring 32. The spring 32 is configured and designed as a cup spring, and arranged to preload the VTG guide grid 1 in the axial direction 2 in the turbine casing 112. The spring 32 lies in indirect contact via a heat shield on the vane bearing ring 30. On the axially opposite side, the spring 32 rests on the bearing housing 130. This means that the spring 32 is clamped between the bearing housing 130 and the vane bearing ring 30. In alternative embodiments, the spring 32 may also lie in direct contact on the vane bearing ring 30. The spacing elements 10 are designed to transmit the preload force from the vane bearing ring 30 to the turbine casing 112 (FIG. 1c) or to a counter-element 38 arranged in the turbine casing 112 (FIG. 1b). The preload may also be achieved by alternative methods other than by a spring, or by one or more preload elements other than a cup spring.

Although the present invention has been described above and is defined in the appended patent claims, it should be understood that the invention may alternatively also be defined according to the following embodiments:

1. A radial turbine (110) for a charging device, (100) comprising:
a turbine casing (112) defining a supply channel (113) and an outlet channel (115),
a turbine wheel (114) which is arranged in the turbine casing (112) between the supply channel (113) and the outlet channel (115),
a VTG guide grid (1) with a vane bearing ring (30) and a plurality of guide vanes (40) which are mounted rotatably in the vane bearing ring (30) along a respective vane axis (42a) and each have a vane length (48) between a leading edge (44) and a trailing edge (46),
a plurality of spacing elements (10) which are arranged on the vane bearing ring (30) and distributed in the circumferential direction (6) such that they define an axial distance (36) of the vane bearing ring (30) from the turbine casing (112) or from a counter-element (38) arranged in the turbine casing (112), wherein
at least one spacing element (10) of the plurality of spacing elements (10) is arranged adjacent to a guide vane (40) of the plurality of guide vanes (40) and is configured such that
a minimum distance (16) between the at least one spacing element (10) and the associated adjacent guide vane (40) is achieved in a specific operating position of the guide vane (40) in which the minimum distance (16) is formed by a difference between:
   ◯ an axial distance (41) which corresponds to the distance of the vane axis (42a) from the spacing element (10), and
   ◯ an inflow distance (45) which corresponds to the distance of the vane axis (42a) from the leading edge (44).

2. The radial turbine (110) according to embodiment 1, wherein distances from the at least one spacing element (10) to all guide vanes (40) other than the associated adjacent guide vane (40) in each operating position of the guide vanes (40) are greater than the minimum distance (16).

3. The radial turbine (110) according to any of the preceding embodiments, wherein the associated adjacent guide vane (40) in the specific operating position for achieving the minimum distance (16) is oriented with the leading edge (44) in the direction of the spacing element (10).

4. The radial turbine (110) according to any of the preceding embodiments, wherein the axial distance (41) is greater than the inflow distance (45).

5. The radial turbine (110) according to any of the preceding embodiments, wherein the minimum distance (16) exists between the leading edge (44) and the spacing element (10).

6. The radial turbine (110) according to any of the preceding embodiments, wherein the VTG guide grid (1) is configured such that a ratio V ₁ of the minimum distance (16) to the vane length (48) lies in a range from 0.01 to 0.1, preferably in a range from 0.02 to 0.05, and particularly preferably in a range from 0.025 to 0.040.

7. The radial turbine (110) according to any of the preceding embodiments, wherein the spacing elements (10) are configured so as to be substantially cylindrical.

8. The radial turbine (110) according to any of the preceding embodiments, wherein the spacing elements (10) each comprise an engagement portion (12) and a spacing portion (14).

9. The radial turbine (110) according to embodiment 8, wherein the spacing elements (10) are configured for arrangement, in particular press-fit, via the engagement portion (12) in one of the vane bearing ring (30) or turbine casing (112), in particular in a counter-element (38) arranged in the turbine casing (112).

10. The radial turbine (110) according to embodiment 9, wherein the spacing portion (14) is arranged in contact with the contact face of the other of the vane bearing ring (30) or the turbine casing (112), in particular a counter-element (38) arranged in the turbine casing (112).

11. The radial turbine (110) according to embodiment 10, wherein the contact face is designed to be wear-resistant.

12. The radial turbine (110) according to any of embodiments 8 to 11, wherein the spacing elements (10) each comprise a support portion (13) with a support diameter (13a) which is axially arranged between the engagement portion (12) and the spacing portion (14), and optionally

wherein the support diameter (13a) is greater than an engagement diameter (12a) of the engagement portion (12) and greater than a spacing diameter (14a) of the spacing portion (14).

13. The radial turbine (110) according to embodiment 12, wherein the spacing diameter (14a) is greater than the engagement diameter (12a).

14. The radial turbine (110) according to any of embodiments 8 to 11, wherein a spacing diameter (14a) of the spacing portion (14) is greater than an engagement diameter (12a) of the engagement portion (12).

15. The radial turbine (110) according to any of embodiments 12 to 14, wherein the spacing elements (10) are configured such that a ratio V ₂ of the engagement diameter (12a) to the spacing diameter (14a) lies in a range from 0.5 to 1.0, preferably in a range from 0.6 to 0.95, and particularly preferably in a range from 0.7 to 0.9.

16. The radial turbine (110) according to any of the preceding embodiments, wherein the plurality of guide vanes (40) is greater than the plurality of spacing elements (10).

17. The radial turbine (110) according to any of the preceding embodiments, wherein a ratio V ₃ of the plurality of guide vanes (40) to the plurality of spacing elements (10) lies in a range from 1.1 to 3.0, preferably in a range from 1.5 to 2.5, and particularly preferably in a range from 1.75 to 2.25.

18. The radial turbine (110) according to any of the preceding embodiments, wherein the plurality of spacing elements (10) comprises at least three spacing elements (10).

19. The radial turbine (110) according to any of the preceding embodiments, wherein the plurality of spacing elements (10) comprises a number between one and twenty, in particular between two and fifteen, preferably between three and ten.

20. The radial turbine (110) according to any of the preceding embodiments, furthermore comprising a spring (32), in particular a cup spring, which is designed and arranged to preload the VTG guide grid (1) in the axial direction in the turbine casing (112), wherein the spacing elements (10) are configured to transfer the preload force from the vane bearing ring (30) to the turbine casing (112) or to a counter-element (38) arranged in the turbine casing (112).

21. The radial turbine (110) according to any of the preceding embodiments, wherein the guide vanes (40) each comprise a vane shaft (42) and a vane lever (43), wherein the vane levers (43) are operatively coupled to an adjustment ring (20) of the VTG guide grid (1), wherein the guide vanes (40) are rotatably mounted in the vane bearing ring (30) via the vane shafts (42) and distributed in the circumferential direction (6).

22. The radial turbine (110) according to any of the preceding embodiments, wherein the guide vanes (40) can be adjusted between a first position, which corresponds to a maximally opened position of the VTG guide grid (1), and a second position which corresponds to a minimally opened position of the VTG guide grid (1).

23. The radial turbine (110) according to embodiment 22, wherein the respective center axes (11) of the spacing elements (10) are arranged radially inside an envelope circle diameter D_{Smax} which is formed by positions of the leading edges (44) in the maximally opened position of the VTG guide grid.

24. The radial turbine (110) according to embodiment 23, wherein the center axes (11) of the spacing elements (10) are arranged on an envelope circle with a center axis diameter D_{P}, wherein a ratio V₄ of the center axis diameter D_{P} to the envelope circle diameter D_{Smax} lies in a range from 0.8 to 1.0, preferably in a range from 0.9 to 1.0, and particularly preferably in a range from 0.95 to 1.0.

25. The radial turbine (110) according to any of the preceding embodiments, wherein the counter-element (38) is configured as an annular element, in particular as a cover disc.

26. The radial turbine (110) according to any of the preceding embodiments, wherein the VTG guide grid (1) is arranged axially outside the turbine wheel (114).

27. The radial turbine (110) according to any of the preceding embodiments, wherein each spacing element (10) of the plurality of spacing elements (10) is arranged adjacent to a respective guide vane (40) of the plurality of guide vanes (40), and configured such that:
a minimum distance (16) between the at least one spacing element (10) and the associated adjacent guide vane (40) is achieved in a specific operating position of the guide vane (40) in which the minimum distance (16) is formed by a difference between:
   o an axial distance (41) which corresponds to the distance of the vane axis (42a) from the spacing element (10), and
   o an inflow distance (45) which corresponds to the distance of the vane axis (42a) from the leading edge (44).

28. The radial turbine (110) according to any of the preceding embodiments, wherein each spacing element (10) of the plurality of spacing elements (10) is arranged adjacent to a respective guide vane (40) of the plurality of guide vanes (40) and configured according to the features of any of the preceding embodiments.

29. A charging device (100) for an internal combustion engine or a fuel cell, comprising:
a bearing housing (130),
a shaft (140) which is rotatably mounted in the bearing housing (130),
a compressor (120) with a compressor wheel (124),
a radial turbine (110) according to any of the preceding embodiments, wherein the turbine
wheel (114) and the compressor wheel (124) are arranged rotationally fixedly at opposite ends on the shaft (140).

30. The charging device (100) according to embodiment 29, furthermore comprising an electric motor.

31. The charging device (100) according to embodiment 30, wherein the electric motor is configured to drive the shaft (140) in rotation.

32. The charging device (100) according to any of embodiments 29 to 31 insofar as dependent on embodiment 20, wherein the spring (32) is clamped between the bearing housing (130) and the vane bearing ring (30).

List of Reference Signs

| R | Rotational axis |
|---|---|
| Dp | Center axis diameter |
| D_{Smax} | Envelope circle diameter |
| V1 | Ratio of 16 and 48 |
| V2 | Ratio of 12a and 14a |
| V3 | Ratio of number of guide vanes to number of spacing elements |
| V4 | Ratio of D_{P} and D_{Smax} |
| 1 | VTG guide grid |
| 2 | Axial direction |
| 4 | Radial direction |
| 6 | Circumferential direction |
| 10 | Spacing element |
| 11 | Center axis |
| 12 | Engagement portion |
| 12 a | Engagement diameter |
| 13 | Support portion |
| 13 a | Support diameter |
| 14 | Spacing portion |
| 14 a | Spacing diameter |
| 16 | Minimum distance |
| 20 | Adjustment ring |
| 24 | Engagement opening |
| 30 | Vane bearing ring |
| 32 | Cup spring |
| 36 | Axial distance |
| 38 | Counter-element |
| 40 | Guide vanes |
| 41 | Axial distance |
| 41 a | Distance circle |
| 42 | Vane shaft |
| 42 a | Vane axis |
| 43 | Vane lever |
| 44 | Leading edge |
| 45 | Inflow distance |
| 45 a | Leading edge circle |
| 46 | Trailing edge |
| 47 | Outflow distance |
| 48 | Vane length |
| 60 | Actuating device |
| 100 | Charging device |
| 110 | Radial turbine |
| 112 | Turbine casing |
| 113 | Supply channel |
| 114 | Turbine wheel |
| 115 | Outlet channel |
| 120 | Compressor |
| 122 | Compressor housing |
| 124 | Compressor wheel |
| 130 | Bearing housing |
| 140 | Shaft |

1. A radial turbine (110) for a charging device, (100) comprising:
a turbine casing (112) defining a supply channel (113) and an outlet channel (115),
a turbine wheel (114) which is arranged in the turbine casing (112) between the supply channel (113) and the outlet channel (115),
a VTG guide grid (1) with a vane bearing ring (30) and a plurality of guide vanes (40) which are mounted rotatably in the vane bearing ring (30) along a respective vane axis (42a) and each have a vane length (48) between a leading edge (44) and a trailing edge (46), and
a plurality of spacing elements (10) which are arranged on the vane bearing ring (30) and distributed in the circumferential direction (6) such that they define an axial distance (36) of the vane bearing ring (30) from the turbine casing (112) or from a counter-element (38) arranged in the turbine casing (112),
wherein at least one spacing element (10) of the plurality of spacing elements (10) is arranged adjacent to a guide vane (40) of the plurality of guide vanes (40) and is configured such that the minimum distance (16) between the at least one spacing element (10) and the associated adjacent guide vane (40) is achieved in a specific operating position of the guide vane (40) in which the minimum distance (16) is formed by a difference between:
an axial distance (41) which corresponds to the distance of the vane axis (42a) from the spacing element (10), and
an inflow distance (45) which corresponds to the distance of the vane axis (42a) from the leading edge (44), and
wherein distances from the at least one spacing element (10) to all guide vanes (40) other than the associated adjacent guide vane (40) in each operating position of the guide vanes (40) are greater than the minimum distance (16).

2. (canceled)

3. The radial turbine (110) as claimed in claim 1, wherein the associated adjacent guide vane (40) in the specific operating position for achieving the minimum distance (16) is oriented with the leading edge (44) in the direction of the spacing element (10).

4. The radial turbine (110) as claimed in claim 1, wherein the VTG guide grid (1) is configured such that a ratio V₁ of the minimum distance (16) to the vane length (48) lies in a range from 0.01 to 0.1.

5. The radial turbine (110) as claimed in claim 1, wherein the spacing elements (10) each comprise an engagement portion (12) and a spacing portion (14).

6. The radial turbine (110) as claimed in claim 5, wherein the spacing elements (10) are configured for arrangement via the engagement portion (12) in one of the vane bearing ring (30) or turbine casing (112).

7. The radial turbine (110) as claimed in claim 6, wherein the spacing portion (14) is arranged in contact with the contact face of the other of the vane bearing ring (30) or the turbine casing (112) and
wherein the contact face is wear-resistant.

8. The radial turbine (110) as claimed in claim 5, wherein spacing elements (10) each comprise a support portion (13) with a support diameter (13a) which is axially arranged between the engagement portion (12) and the spacing portion (14), at least one of:
the support diameter (13a) is greater than an engagement diameter (12a) of the engagement portion (12) and greater than a spacing diameter (14a) of the spacing portion (14), and
the spacing diameter (14a) is greater than the engagement diameter (12a).

9. The radial turbine (110) as claimed in claim 5, wherein a spacing diameter (14a) of the spacing portion (14) is greater than an engagement diameter (12a) of the engagement portion (12).

10. The radial turbine (110) as claimed in claim 8, wherein the spacing elements (10) are configured such that a ratio V₂ of the engagement diameter (12a) to the spacing diameter (14a) lies in a range from 0.5 to 1.0.

11. The radial turbine (110) as claimed in claim 1, wherein a ratio V₃ of the plurality of guide vanes (40) to the plurality of spacing elements (10) lies in a range from 1.1 to 3.0.

12. The radial turbine (110) as claimed in claim 1, wherein the guide vanes (40) can be adjusted between a first position which corresponds to a maximally opened position of the VTG guide grid (1), and a second position which corresponds to a minimally opened position of the VTG guide grid (1), and
wherein the respective center axes (11) of the spacing elements (10) are arranged radially inside an envelope circle diameter D_{Smax} which is formed by positions of the leading edges (44) in the maximally opened position of the VTG guide grid.

13. The radial turbine (110) as claimed in claim 12, wherein the center axes (11) of the spacing elements (10) are arranged on an envelope circle with a center axis diameter D_{P}, wherein a ratio V₄ of the center axis diameter D_{P} to the envelope circle diameter D_{Smax} lies in a range from 0.8 to 1.0.

14. The radial turbine (110) as claimed in claim 1, wherein each spacing element (10) of the plurality of spacing elements (10) is arranged relative to a respective guide vane (40) of the plurality of guide vanes (40) and configured according to one or more of the features claimed in claim 1.

15. A charging device (100) for an internal combustion engine or a fuel cell, comprising:
a bearing housing (130),
a shaft (140) which is rotatably mounted in the bearing housing (130),
a compressor (120) with a compressor wheel (124),
a radial turbine (110) as claimed in claim 1, wherein the turbine wheel (114) and the compressor wheel (124) are arranged rotationally fixedly at opposite ends on the shaft (140).

16. The radial turbine (110) as claimed in claim 1, wherein the VTG guide grid (1) is configured such that a ratio V₁ of the minimum distance (16) to the vane length (48) lies in a range from 0.02 to 0.05.

17. The radial turbine (110) as claimed in claim 1, wherein the VTG guide grid (1) is configured such that a ratio V₁ of the minimum distance (16) to the vane length (48) lies in a range from 0.025 to 0.040.

18. The radial turbine (110) as claimed in claim 5, wherein the spacing elements (10) are configured for press-fit arrangement via the engagement portion (12) in one of the vane bearing ring (30) or turbine casing (112) in a counter-element (38) arranged in the turbine casing (112).

19. The radial turbine (110) as claimed in claim 5 , wherein the spacing portion (14) is arranged in contact with a contact face of the counter-element (38) arranged in the turbine casing (112), and wherein the contact face is wear-resistant.

20. The radial turbine (110) as claimed in claim 1, wherein a ratio V₃ of the plurality of guide vanes (40) to the plurality of spacing elements (10) lies in a range from 1.5 to 2.5.
